(19) United States
(12) Patent Application Publication
(10) Pub. No.: US 2013/0052617 A1
(43) Pub. Date: Feb. 28, 2013

(54) Use of beads on a rope, with a parallel printed sequence

(71) Applicant: James Richard Harte, Kansas City, MO (US)

(72) Inventor: James Richard Harte, Kansas City, MO (US)

(21) Appl. No.: 13/199,151

(22) Filed: Aug. 22, 2011

(51) Int. Cl. G09B 19/02

(52) U.S. Cl. 434/203

(57) ABSTRACT

This invention is designed to help students learn to: count, add, subtract, multiply, divide, and learn the multiplication tables, by the use of a rope attached to a narrow board, where this rope contains a variable number of beads of the same size, that can be shifted back and forth.

This innovation also uses a printed number sequence that is located parallel to, but above or below the rope and beads that are located on this narrow board. And this rope is permanently attached to a wooden block on the left side of the wood strip. And all beads that are pushed against this left side block are “counters”. And the other beads on this rope are “non-counters”. And when beads become “counters”, the number that appears above each bead gives its number, in a left to right sequence. And the number that appears above each “counter” bead gives the student use visual feedback to help that student learn the math processes noted above.

### 1.) CROSS REFERENCES TO RELATED PATENTS

The major cross reference is my current pending application: Augmented Simple Abacus With An Underlying Grid of Numbers, or a Blank Sheet: Application Ser. No. 12/804,825; Filing Date: Jul. 30, 2010.

Patents with some relevance to this current patent application include:

| | U.S. Patents Granted | Granted | Filing Date: | Class/ |
|---|---|---|---|---|
| Numbers: | to: | on: | on: | Subclass: |
| 1,099,009 | R. C. Bennett | Jun. 2, 1914 | Jun. 21, 1914 | 434/203 |
| 1,142,651 | T. Winiecki | Jun. 8, 1915 | Oct. 10, 1913 | 434/203 |
| 1,441,323 | A. J. Barber | Jan. 9, 1923 | Jul. 3, 1921 | 434/2.03 |
| 2,556,501 | G. A. Limyr | Jun. 12, 1951 | Aug. 2, 1948 | 434/203 |
| 5,149,269 | Howard Ylitato | Sep. 22, 1992 | May 20, 1991 | 434/203 |
| 5,334,026 | Howard Yliato | Aug. 2, 1994 | Jun. 7, 1993 | 434/203 |

### NO FEDERAL FUNDS WERE USED IN THE RESEARCH OR IN THE DEVELOPMENT OF THIS PATENT APPLICATION

### 2.) NO SEQUENCE LISTING; HARD OR SOFT COMPUTER DISK; OR COMPUTER PROGRAM WAS USED WITH THIS PATENT APPLICATION, OTHER THAN THE USE OF A WORD PROCESSOR

### 3.) BACKGROUND OF THE INVENTION

Field of this invention. This invention pertains to teaching and learning tools to help young children master the concepts of: the counting of numbers with a base of ten; simple addition; simple subtraction; simple multiplication and division, and learning the multiplication tables. More specifically, it combines a printed -Number Line that contains an orderly sequence of printed numbers, with an “extended simple abacus” by use of beads on a rope, where these segments of ten beads on a rope parallel a printed number line. This hybrid combination of a printed number line that parallels a rope that has a variable number of beads on it that can be slid back and forth, giving immediate visual and body movement feedback to the user of this hybrid mechanism. And by combining these sensory and motor activities, young learners enhance their learning and memory, as learning and memory are enhanced by multiple sensory inputs and by multiple motor activities that are registered and processed in the developing brain.

This invention is an outgrowth of another invention for which I have applied for a U.S. patent. This related patent has application Ser. No. 12/804,825; a Filing Date of Jul. 30, 2010; and a Title of: Augmented Simple Abacus With An Underlying Grid of Numbers, or a Blank Sheet. Additional Background Information can be found in Application Ser. No. 12/804,825, of: Jul. 30, 2010.

Other relevant background information is that as I grew up in the 1930's, it seemed to me that our world was a crazy place in which to live. And from the daily and weekly news media, it appeared to me that many of the leaders of powerful nations in the world were behaving in crazy and potentially destructive ways toward their neighbors, and ultimately toward the citizens of their own country. And I was about a year too young to be involved in active combat in World War 2.

But two weeks after graduating from high school in June,1946, I enlisted in the U.S. Army. And after basic training I was sent to Korea. And in Seoul, Korea, almost all of the merchants used a classical type of abacus to add up the cost of the items you purchased. And I purchased several of these classical abacuses, and learned how to use them.

And prior to going to medical school, I thought that it might be interesting and worth while to go into the field of psychiatry, to find out why people behaved in crazy ways at times, and what could be done that was helpful for these individuals, their families, and others. And in time this led me to take additional studies and additional training in the area of child and adolescent psychiatry. And between 1957 and 2003 (when I retired), I spent about 80% of my work time in the field of child and adolescent psychiatry. And a part of this work was as a consultant to five different school districts in the Kansas City area. And a part of this work was as a consultant or part time staff to several different psychiatric hospitals and residential treatment centers that served child and adolescent patients.

And year after year about 50% of the child and adolescent patients that I saw and evaluated had serious problems with learning to read English words and sentences. And this high percent of reading and learning disabilities in my patients inspired me to enroll in graduate education classes in: education; reading; special education; educational technology; research methodology, and statistics; at the University of Missouri at Kansas City in the evenings from 1970 until 1980. And in this time span I acquired about 95 semester hours in these areas. And this combined experience of clinical work in child and adolescent psychiatry, and graduate work in education, led me to feel that there had to be a “better way” to help many children learn how to read English words and sentences, and to learn simple math skills. And these observations led me into an ongoing search, or searches to see if there were not “better ways” to help beginning students in learning to read English words, and to learn basic math skills.

In the early 1970's I developed a simple and inexpensive mechanical teaching machine that I called a “Feedback Teaching Machine”. It was given U.S. Pat. Nos. 3,747,229, 3,964,176, and 3,902,255. And I gave a number of these simple mechanical teaching machines to teachers and other educators that I worked with in my work as a psychiatric consultant. And in general the teachers and others found them useful and helpful, and they liked them, as did their students.

And then I thought I should get my simple mechanical Feedback Teaching Machine evaluated in a research way, using a control group, a study group, and using statistics to see if the use of this simple technology made a significant difference in student achievement. And initially, the principals and other administrators liked this idea. But then they looked at the amount of educators time such study would take, and they said the money for this was not in their budget. And the administrators wanted me to pay all of the costs for one or more such studies. And I did not have that kind of money.

And then I had a catalog made up along with other printed material, and I sent this catalog to many of the directors of special education in school districts in the Central part of the United States. But I lost money on this business venture. And so I decided to put my simple Feedback Teaching Machine “on the shelf” for the time being. But I still felt that it needed a controlled research study to see if it actually helped with student achievement.

On one summer day in the late 1980's I was discussing my Feedback Teaching Machine with my long time friend, John Shipper MD, who had recently retired to the Philippines. And John suggested that I bring my teaching materials, and my Feedback Teaching Machine and related instructional sheets to his part of the Philippines, and have them evaluated there. He said in his part of the Philippines all college graduates spoke English, and the cost of getting an adequate evaluation would be much less in his part of the Philippines than in the U.S. A. And this was done.

And in the 1990's I was still working full time in my chosen area of work, child and adolescent psychiatry. But every year in the late 1980→s, and in the 1990's, I spent 2 to 3 weeks in the Northern Philippines, talking with educators at different levels, about some of my ideas, and some of the materials that I had developed, and would like to have evaluated in a controlled research study. And generally I felt that my ideas and my educational materials were well received by educators at all levels. And in the late 1990's the Director of Education for La Union Province, was agreeable to have a study conducted of my materials, on his terms.

Initially I had hoped to have a study done with one classroom of 30 to 35 second grade students, where each student would use my Feedback Teaching Machine with appropriate instructional sheets, twice a day for 30 minutes; during the second semester of school. And have a similar sized classroom in a similar school, that would not be provided with these materials, until the start of the next school year. And base line tests, before the study started, would be done to determine the degree or extent of knowledge and mastery of simple English words, and knowledge of the brief spoken sounds (phonemes) assigned to some of the letters of the alphabet. And these base line tests would be taken by both the control group, and the experimental group, at the beginning of the second semester. And at the end of the second semester a similar test of knowledge of English words, and the spoken sounds assigned to some of the letters of the alphabet would be given to both groups of second grade students, the control group, and the experimental group. (One of my problems was that I felt I had only enough materials in the Philippines for one classroom of 30 to 35 students.)

However, the Director of Education of La Union Province, said he wanted the study done his way. And this was to include all second graders in two elementary schools. And this turned out to be about 150 to 160 second grade students in each elementary school, with 50 to 60 students per classroom. And this created several problems, which I hoped were manageable. But I felt that with the limited materials I had available in the Philippines, to have these materials be spread among 160 second grade students was far less than the optimal use of these materials than I had hoped for.

And the testing of both groups of second grade students at the end of the second semester showed that the control group of students scored higher on recognition of simple English words, and also higher on the spoken sounds assigned to some of the letters of the alphabet. But the person who examined the data, Dr. Rick Barcello, found that the control group of students had also scored far higher on recognition of English words, and the sounds assigned to some of the letters at Base Line Testing. Thus this was a flawed study, as the two groups were not similar at the start of the study. And the control group had a much higher level of knowledge as to English words, and the sounds of some letters of the alphabet at the start of the study.

But a later indirect outcome of this research study was highly significant. Near the end of the first semester, I set up several meetings with the teachers who were to participate in this study. And this included teachers from the control group, and teachers from the research study group. And these meetings were held in a meeting room at the La Union Province Red Cross offices. And it was arranged that the Director of the La Union Province Red Cross would over-see this research study in my absence. And I gave the director of the Red Cross additional instructional materials in the event that some of these materials got lost or were stolen during this second semester study. And the wife of the Director of the Red Cross was interested in these materials and concepts, and joined the meetings where these concepts and materials were explained to the second grade teachers from both schools. And the wife of the director of the La Union Red Cross brought along her 4 year old son, and her three year old daughter. And during lunch her 4 year old son enjoyed playing with these materials. And at lunch on the last day of our meetings, this 4 year old boy asked me: “Can I take some of these things home and play with them there?” And I granted his request.

And about two years later when this lad started first grade, at age 6 years, he was reading English words and sentences quite well. And about half way through first grade, this lad's teacher and principal asked his parents about testing him for his level of knowledge in English word recognition skills, and his level of comprehension of English sentences. And his parents approved this testing. And a little later, it was reported to his parents that his English word recognition skills, and his comprehension of the content of English written sentences were between fifth and sixth grade. And the following year his younger sister started first grade, and her level of English reading skills were very high at that time.

And the friends and acquaintances of this couple soon became aware of this impressive reading ability in English words by these two children. And they wanted to borrow some of these materials for their own young children. And the father of these two children was a member of one of the Rotary Clubs in the City of San Fernando, La Union. And these two children's remarkable progress in learning to read English words and sentences was discussed at Rotary Club meetings. And a committee, designated “The Literacy Committee”, of this Rotary Club, was set up to discuss and decide what to do with this information.

And it was decided to see if some of the many of the Child Day Care Centers in the City of San Fernando, La Union, would like to have access to these materials, and also be shown how to use these materials with their pre-school children, ages 3 thru 6 years. And I was contacted by e-mail about this, and was asked if I were willing to collaborate in this project with 25 Child Day Care Centers in the City of San Fernando, La Union? And I responded by e-mail, that I would collaborate as well as I could, but it would be several months before I could take a trip to the Philippines. (And it later turned out that there are 64 child day Care Centers in the City of San Fernando, that enroll over 4000 children yearly.)

From my observations over the years, I felt that a major problem with learning to read English words in the U.S.A., was that many or most school districts that had control of public schools, emphasized teaching children to read by the Whole Word Method or the “Look See—Look Say Method”. And the Whole Word Method ignored or avoided the teaching of English phonics. And one of the results was that when children reached 4^{th} and 5^{th} grades, and were expected to know how to “sound out” multiple syllable words; many of these children had no idea as to how to sound out even one syllable words. They had never been taught this skill or bit of knowledge about English phonics. And they were headed to become illiterates unless they were helped by someone as to how to sound out English words in a phonic way.

As I saw the situation as to how to teach phonics, it appeared to me that it was best to start with simple three letter words in helping children learn the different spoken sounds (phonemes), assigned to the individual letters, or to small groups of side by side letters. Thus start simple to avoid confusing young children. And I also believed that beginning readers needed a lot of practice and drill with these early and elementary concepts of learning the different brief spoken sounds assigned to the letters of the alphabet, or to letter clusters.

And in the early 1970′s I had located 120 three letter English words that I thought were a good place to start. And by 2000 A.D., I had found 40 additional three letter English words; giving me a total of 160 three letter words; to have beginning readers work with to help learn the individual brief spoken sounds (phonemes) assigned to the letters of the alphabet.

And I developed two types of materials that I hoped would give beginning readers of English words adequate feedback, in the processes of learning the brief spoken sounds assigned to the letters of the alphabet, and also assigned to some letter clusters. The first type of materials were instructional sheets that I put together to operate with the Feedback Teaching Machine that I had developed; that gave direct and rapid feedback to the user as to his or her correct and incorrect responses to multiple choice or cross matching questions. The second type of instructional materials were work sheets on 8.5″×11″ sheets of paper that were to be placed inside of a transparent plastic envelope, such as a “sheet protector”. And the student user was to write in their response to cross matching questions or multiple choice questions in water soluble ink on the surface of this transparent plastic sheet protector. And after the student user had responded to all of the questions on a work sheet, the parent or teacher could then check the accuracy of the responses, and then give good quality feedback to the student user as to their correct and incorrect responses. And a damp cloth could then be used to wipe away the water soluble ink. And this made that worksheet reusable many times.

And when I met with the child day care workers from the 25 (and later 64) Child Day Care Centers, I said that I would give them these two types of teaching materials, if they were agreeable to give their graduates a brief test as to their knowledge of three letter English words, and the brief spoken sounds assigned to the letters in these three letter words, at a later time, such as at the time they graduated from day care. And I told them that I had not as yet developed these tests. But I had some thoughts about the types of information I was looking for. And I also told them that I would give each tester a small amount of money for each adequately completed test. And most of the types of materials were of the reusable worksheet type; plus 80 sheets (160 pages) that had one picture of an object or an action on each page, plus printed below this picture was printed it's three letter word. And I had organized these 160 pages in an alphabetical order from A to Z; or from ace to zoo. (And it was only later that these child care workers helped me understand what a poor arrangement this A to Z sequence was.)

And I then returned to the U.S.A. to think about the type of test I wanted these child care workers to give each of their graduates from day care. And I came up with what I called “A Six Part Test”, where each graduate was to be tested on ten of the 160 three letter words. And these six parts were: 1.) name the picture of an object or action; 2.) read the three letter word of an object or action; 3.) give the brief spoken sound (phoneme) of a consonant; 4.) give the short sound of a vowel; 5.) give the blended sound of a short vowel when it is blended with a consonant; and 6.) read one of the 100 most common words in children's books in the U.S.A. And I prepared eight of these similar Six Part Tests.

And I returned to the City of San Fernando, La Union about 5 or 6 months later, in Nov. 2005 and again met with the child care workers from the 64 child day care centers. And I presented the 8 similar Six Part Test Sheets that I had prepared for them to give their graduates in about 3 to 4 months. (Only one test sheet was to be given to one student at the time of their graduation or before.) And I explained the contents of several of these Six Part Test Sheets. And I told the child care workers that they and the children's parents were free to use these 8 different Six Part Test Sheets as “Teaching Sheets”, at home, or in their child day care center. And then we took a break, and I was open for questions.

And during the break for questions, a group of child care workers came up to where I was standing, and told me that I was pushing things too fast. And several brought along their 160 page booklet, and showed me that they were only up to page 45 or page 50 with their group of pre-schoolers who were due to graduate in 3 to 4 months. And they did not see that they would be able to complete all 160 pages by the time of graduation. And a number of these child day care workers complained about having to teach their children words that began with the letter A first, (as the 160 words went from A to Z). And several of the child day care workers said that the words that started with A were the most confusing words in the 160 words. And several proposed that I throw out most of the words that started with the letter A, as these words were too difficult for 4 and 5 year old children to learn. And as I scanned the first seven words of the 160 words they all started with the letter A. I thought I saw the problem. In these seven words, the letter A is given three different spoken sounds (3 phonemes). Examples of this are: in the words: ace, and ape the letter A has a long vowe sound. In the words: add, ant, and ax the letter A has a short vowel sound. And in the words: art and arm, the letter A is “r-controlled”.

And hearing about how these child care workers struggled with three of the sounds (phonemes) assigned to the letter A, this was a kind of: “Flash of Insight” for me. This insight was where the focus of teaching English phonics needed to be. This was where the “better way” was to be found. This was an illustration of a need that teachers and young beginning students had. This very much pointed out the need to focus on learning all, or most, of the spoken sounds (phonemes) assigned to the different letters of the alphabet, and to the phonemes of the many “letter clusters” found in English words.

But what was this better way? What did it look like? How was it composed? How was it made up? How was it organized? What sequence did it follow? How was it to be presented? And in thinking abut these questions, I decided that I needed a better understanding of English phonics. And on returning to the U.S.A., I spent a great deal of time on the internet, mostly Google, to gain more information about phonics. But I also re-read parts of books on teaching English phonics that I had purchased in the previous forty years. And this extended search led me to the ideas and concepts that make up what I call: “Progressive Synthetic Phonics”. And Progressive Synthetics Phonics contains not only some of my older ideas, but some newer ones also. And again I searched the internet, and then the U.S. patents on English phonics, and I was not able to come up with the same range of ideas that were combined into one whole unit. And then I decided to file for a U.S. Patent on this newer way of looking at teaching English phonics. And this patent application was given the Ser. No. 12/589.878, with a filing date of: Oct. 30, 2009. Several months ago I received notice that this patent has been granted, but I have mislaid this correspondence.

And after completing all of the paper work to file for a U.S. Patent on “Progressive Synthetic Phonics”, I said to myself: “Now you have the time to see if there is a better way to help beginners learn math. And since 1946 in Seoul, Korea I had continued to be intrigued by the use of abacuses. And from the time of my entry into child and adolescent psychiatry in 1957, I had encountered a number of children and adolescents who had trouble grasping the concepts of: addition, subtraction, multiplication, and division. And from time to time between 1957 and 2003, I kept one or two types of abacuses in my office desk, and I used these abacuses to help show children in a concrete way how our numbering system with a base of ten was used. And between 1970 and 2003, I made twenty or more abacuses of simple type, and of traditional type. And I made these abacuses from: beads, rods or rope, and wooden frames. And I gave a number of these abacuses to children who appeared to be in need of more practice and drill in a concrete way to help master number and math concepts. And as I thought about the above, I thought: “wouldn't it be nice if the beads in an abacus had their number printed on each bead”. But I realized this would be an expensive process to build and assemble. And then I had the thought: “Why not print the numbers of the beads on a sheet of paper, and position this paper under the rows of beads on a simple abacus”. And then I thought: “Give the abacus a solid floor under the rows of rods and beads, and position this printed sheet of numbers on this solid floor.” And I built such an abacus. And in looking at the grid of numbers on the sheet, I could see where by deleting the odd numbers you could teach the even numbers. And in a similar way, by deleting numbers 1 & 2, and then 4 &5, and then 7 & 8, and then 10 & 11, and so on, you could help the beginning learner see in a concrete way the multiplication tables of the “threes”. And in similar ways you could set up other sheets to be positioned under the rows of the beads, to help teach other multiplication tables. And I made these sheets to help young learners learn the multiplication tables in a concrete way. And I then decided to do a U.S. patent search in class 434 and subclass 203 that pertains to abacus like tools, to see if these concepts had been previously patented. And when I could find no similar patents, I decided to file for a U.S. Patent on these concepts. For details of the above, please refer to: application Ser. No. 12/804,825; filing date Jul. 30, 2010.

And later in playing with, and looking at, one of the simple abacuses with ten rows of beads on ten rods, that I had built; it became evident that one could “stretch out” these ten rows of beads, with their accompanying ten rows of numbers, into a single long line of ten segments, where each segment had ten numbers, or potentially each segment had ten consecutive beads. And then in building this type of Number Line, I thought that a flexible rope would work better than one long rod, that might hold 60 or 100 beads. And this rope had to have its left end permanently fastened to the left side of this mechanism. And the right end of this rope could be allowed to be removed from its slot to increase or decrease the number of beads; or to change the colored patterns of beads on this rope. And this is the essence of this U.S. patent application.

### 4.) BRIEF SUMMARY OF THE INVENTION

This invention is about a comparatively simple mechanical mechanism that can help children who need to master the simple math skills of: counting, addition, subtraction, multiplication, division, and the multiplication tables. And the children learn these counting and math skills by moving beads back and forth on a rope that overlies a narrow board like surface. And paralleling this tight straight rope over a narrow board, is a printed number sequence that is placed permanently or temporarily on the upper surface of this narrow board. And the numbers in this sequence are of a size and location so that when the groups of beads that are on this rope are pressed or pushed against a block of wood on the left hand side of this narrow board, each bead has its own number, in the sequence of numbers located above or below that bead.

And the beads on this rope can vary in number. And the user of this “Number Line of Beads” can freely move the beads back and forth on this tightened rope. And the left side of this rope is permanently attached to a block of wood. And this block of wood on the left side of the narrow board acts like the “counter board” of an abacus: This means that all beads in a group of beads that are pressed against the right edge of this left block are “counters”. And the beads on this rope that are not pressed against this left hand block are “non-counters”. With this arrangement, single beads, or groups of 2 or more beads can be moved from the “non-counter” group, and added to the “counter group. Or vice-versa, single beads or groups of beads can be moved from the “counter group” to the “non-counter group”. And in this way beginning learners of counting and simple math skills, can see and experience in a concrete way the processes of: counting, simple addition, simple subtraction, multiplication, division, and the multiplication tables.

### 5.) BRIEF DESCRIPTION OF THE SEVERAL VIEWS OF THE DRAWINGS:

### Please Use Drawing #2 Near the Abstract When this Patent is Printed

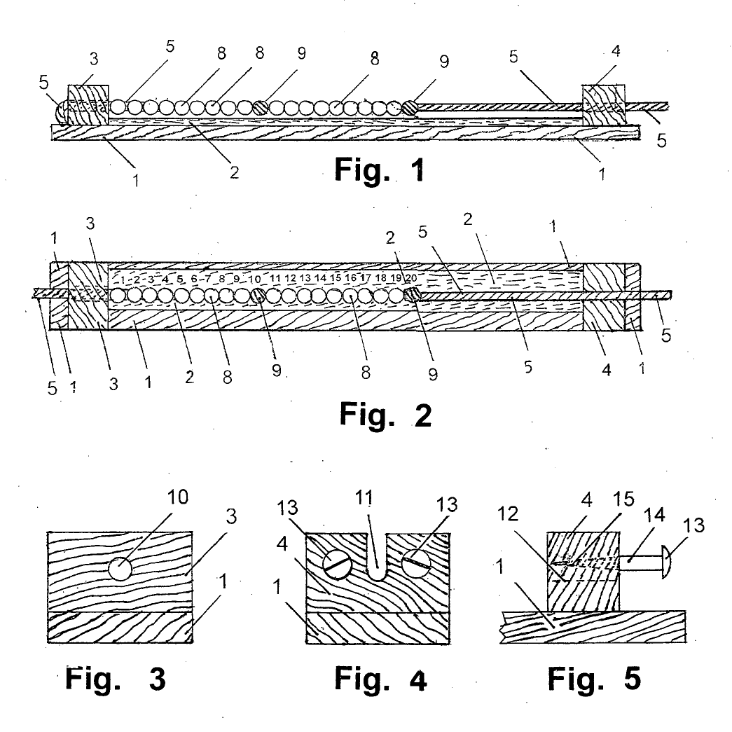

FIG. 1 of the five drawings is a front view of “The Use of Beads on a Rope as a Number Line”. In FIG. 1, #1 is a narrow rigid board, where we are viewing the thickness of the board, as it lies under the other parts of this invention. Number 2 is a view of the edge of a strip of paper or plastic, on which are printed a 1 to 20 sequence of numbers (this is best shown in FIG. 2). Number 3 is a rectangular block of wood on the left hand side, that is premanently fastened to the underlying narrow board by glue and mechanical fasteners. And block #3 has hole #10 through it, in the long deminsion of the underlying narrow board. And #5, is a rope that passes through hole #10. And the left end of rope #5 is permanently mechanically fastened to the left hand side of wood block #3. (See FIG. #3 for details of hole #10.)

In FIG. 1, #4 is a block of wood on the right hand side of narrow board #1, that is permanently fastened to underlying narrow board #1, by glue and mechanical means. And block of wood #4 has a left to right slot #11 in it's upper surface, that permits rope #5 to be easily placed in this slot #11, and easily removed from this slot. (See FIGS. 4 & 5.)

In FIG. 1, #8 and #9, are beads that can be moved back and forth on rope #5. And all of the beads on rope #5 have a value of one each, when that bead, or when its adjacent neighboring beads are pushed against the right side of the left block, block #3. This left hand side block #3 is called “the counting block”. And when any of the beads that are in a group of beads that are pushed away from the group of beads that are pushed against block #3, they loose their value of one for each per bead; when that bead is is pushed away from the “counting group”, and pushed toward bock #4, the “non-counter” block, that is on the right hand side of this apparatus, Beads #8 show one color of bead. And beads #9 show a different color of bead. In the bead arrangement shown, bead #9 appears at the locations of printed #10, and printed #20, as this is shown in FIG. 2.

FIG. 2, is a top view of the apparatus shown in a front view in FIG. 1. And the same numbers are used, as are used in FIG. 1, to describe the parts of this teaching apparatus that I choose to call: “Use of Beads on a Rope as a Number Line.” However this top view gives a view of the number sequence of #1 to #20, that are printed on sheet of material #2, that is permanently attached to the upper surface of narrow board #1. And the numbers printed on strip of material #2, are of a size and location, that they indicate to the user, the number of the bead that is located directly below this printed number; when the user has this mechanism properly located in front of him or her; and when one or more of the beads #8 and #9 on rope #5, are pushed against the right hand flat surface of “counting block”, block #3. And the user can move any number of beads, #8 and #9 to the right of block #3 so they are no longer directly or indirectly pushing against “counter block” #3. (And these beads then become “non-counters”.)

And beads #9, below printed number 10 and printed number 20 are of a different color than the other beads. And beads of two or more different colors beads are used to help the beginning math student learn that in our numbering system we use a numbering system with a “base of ten”.

In FIG. 2, this top view shows that rope #5 goes through a drilled hole #10, in block #3. And that rope #5 goes through slot #11 in block #4 (where the top is open to make it easy to remove the right end of rope #5, from block #4, to remove some beads; or to add more beads; or to add beads of different colors, or to add beads of different color patterns. And though FIGS. 1 and 2 show only 20 beads; any number of beads can be added, to this apparatus, if the space between the last bead pushed against “counter block” #3, and “non-counter” block #4, is sufficiently large to hold more beads. Thus twenty beads may be appropriate for beginners, or 4 and 5 year olds. But older and more knowledgeable students can and should use up to 100 beads in much longer similar mechanisms to help students learn various math processes.

FIG. 3, is an end view of the left side of the frame of this mechanism, and it more clearly illustrates hole #10, through which rope #5 passes through block #3, to hold rope #5 in its proper position or location, above but parallel to narrow board #1.

FIG. 4, is an end view of the right side of the frame of this mechansm, and, it more clearly shows slot #11, in which rope #5 can be placed before rope #5 is tightened. and then wrapped around, and/or looped over and under the two wood screws #13, that are screwed into the right side of block #4, (the non-counter block).

FIG. 5 is an enlarged view of the right side of this apparatus, as it is shown in FIG. 1. And FIG. 5 also shows a broken line #12, which indicates the bottom surface of slot 11, on which rope #5, will usually rest, after it has been pulled tightly toward the right, and then looped around the two shanks #14, of two wood screws #13, to help form a knot. These two wood screws #13, have smooth shanks #14, and also have tapered threads #15 that help hold these two screws firmly in block of wood #4.

### 6.) DETAILED DESCRIPTION OF THE INVENTION

This invention is another way to help students learn to: count; add numbers; subtract numbers; multiply numbers; divide numbers; and learn the multiplication tables. This invention uses a number line with successive numbers from; one to 20; or one to 30; or one to 40; or one to 50; and so on, until one to 100 is reached.

This invention has a number of parts. This invention uses: 1.) a narrow flat strip of wood or similar rigid material; 2.) permanently attached to the upper surface of this strip of rigid material are two wooden rectangular blocks; one block being near the left edge of the long wooden strip, and the other block being near the right edge of this long narrow strip of material. These two blocks are mounted on this narrow strip of wood at ninety degrees to the long axis of this long narrow strip. Both of these wooden blocks have holes through them, or a slot in the top in a left to right manner, where these holes or slots are sufficiently large that a rope can be easily passed through both of these holes or slots in these two blocks: 3.) A rope or cord of suitable diameter has its left end permanently attached to the left hand block above this long narrow rigid strip of material. The right end of this rope can be freely passed through a hole or slot in the right hand block. And this rope can be easily removed from the hole or slot in this block on the right hand side of this narrow strip. 4.) Beads of the same size and diameter can be easily threaded onto the right end of this rope. And these same beads can also be easily removed from the right end of this rope, after this rope has been removed from the hole or slot in the block on the right side of the narrow strip. This hole or slot in the right hand block parallels the left to right axis of this narrow strip of rigid material. (And this arrangement permit's a varying number of beads of the same size and diameter—but of varying colors—to be threaded onto, or removed from this rope.)

A printed sequence of numbers is to be printed above or below this row of beads directly on this narrow long strip of rigid material; or this strip of numbers can be printed on a long narrow strip of paper or opaque plastic which is to be permanently or temporarily attached to the upper surface of this long narrow strip, between the two wooden blocks. And in this sequence of printed numbers, from 1 to 20; or from 1 to 30; or from one to 40; or from 1 to 50; and so on up to 1 to 100; is to be of a size (and with a spacing between numbers), so that each number in this printed sequence of numbers, will appear above or below a bead that is in a group of beads that are pressed or pushed against the right side of this left wooden block, (the “counter block”).

And the users of this mechanism can move additional beads into the “counter group”, from the “non-counter group”, as in the process of addition. Or the user an push a given number of beads away from the “counter group”, into the “non-counter group”, as in the process of subtraction; or in the process of “taking away” a number of beads from the counter group.

And the parent, teacher, or mentor can use different colors of beads to indicate certain numbers, such as numbers ending in a “5” being yellow; and numbers ending in a “0” being orange; to help beginners understand numbers with a base of 10; and to also to help beginners understand the “times 5 multiplication tables”, and the “times 10 multiplication tables”. And in a similar manner, the parent, teacher or mentor can remove all of the beads from the rope, and then add a new set of beads that are arranged to indicate a different set of multiplication tables. An illustration of this is where the beads in the locations of numbers: 1, 2, 4, 5, 7, 8, 10, 11, 13, 14, 16, 17, 19, 20, 22, 23, 25, 26, 28, and 29 are all white beads. And where beads number: 3, 6, 9, 12, 15, 18, 21, 24, 27, and 30 are all green beads. And as the user of this mechanism pushes the green beads from the “non-counter” area, into the “counter area”; three (2 white and 1 green) beads at a time, the user can clearly see the relationships of the multiples of the number “3” to the other numbers in this group of 30 beads. And the user of this mechanism can experience the actions of their own choice, and the consequences of these actions, in illustrating the “times 3 multiplication tables”. And in a similar manner the user of this mechanism can see and physically experience the other multiplication tables of numbers under 10×10.

And in an arrangement where all of the beads representing numbers ending in zero, are of one color, (such as black); and where all of the other beads are of a different color (such as white); the student user can be asked to double or triple the number of beads in the “counter group”; and can also be shown by the mentor how to do this. Thus this is a simple and concrete way of learning about multiplication. Or the student user can be asked to divide the group of beads touching the “counter block” into three equal groups. But some numbers cannot be evenly divided by the number 3, and so there will often be a “remainder”. An example of this is 3 divided into 11 will go 3 times, with a remainder of 2. And with this process, the student can be shown how to write down these simple math problems, such as 3 times 5=15. Or the student may be asked to write down 16 divided into 3 equal parts, plus a remainder. And here one has 3 divided into 16=5, plus a remainder of one.

It is my belief and conviction that beginners in learning about math processes, learn best and quickest when they start with concrete materials that they can manipulate in a variety of ways. And to my way of thinking, this simple mechanical mechanism of “ The Use of Beads on a Rope as a Number Line, With A parallel Printed Number Sequence” provides multiple types of sensory inputs, and several types of movement or motor feedback to the beginning math student as to how arithmetic works.

In the drawings that accompany this patent application are shown two wood screws that extend from the right side of the right wooden block. The purpose of these two wood screws are to provide a means where the right end of the rope can be drawn tightly after it has been pushed through the hole or laid in the slot in the right wooden block. And the rope can then be looped under and around these two wood screws to tightly fasten this rope to the right side of the right block. And this tightening causes the rope to become a straight line that parallels the top and bottom edges of the long slim flat surface; and also parallels the printed number sequence that in located on the top of this flat slim surface.

And when this narrow board is long, such as to accommodate a total of 100 beads, on this rope, a metal hinge, cloth hinge, or flexible plastic hinge may be located near the center of this long narrow strip. And this hinge permits this long strip to be folded into a shorter and more easily stored apparatus, when it is not in use.

The drawings of this invention show the above mentioned parts, (except for the hinge.) And the drawings also show the relationships of some of these parts with other parts.

1. Claim 1, is a claim for a mechanism that is constructed of: a flat narrow surface on which is placed a sequence of printed numbers; where such numbers indicate the number of a bead on a rope that is stretched between two wooden blocks (or other material that is elevated above the flat surface), where this elevation permits beads on a tight rope or similar flexible material, to be shifted back and forth from left to right, or from right to left; and where when a group of beads on this rope is pushed against the left hand block, the number of each bead in a one to ten number sequence (or higher) is directly under (or over) the printed number that is on the underlying flat narrow surface. And the printed number sequences may vary from one to ten; up to, one to one hundred.

2. Claim 2 is where the mechanism described in claim One, has a rope permanently attached to the block or elevation on the left side of that flat narrow surface, but the right hand end of this rope can be moved freely back and forth through a hole or slot or groove in this right hand block; and the right hand end of this rope can be secured and tightly held inside of this hole, notch, or groove in the right hand block in a variety of ways to result in the rope being in a tight, straight line, so that this rope is parallel with the sequence of printed numbers, and is also parallel to the top and bottom edges of this narrow flat surface.

3. Claim 3 is the mechanism as described in claims: 1 and 2, that is to be used by young students to gain knowledge and skills about: 1.) the counting of numbers; 2.) simple addition: 3.) simple subtraction; 4.) understanding our numbering system with a base of ten; 5.) understanding simple multiplication and simple division; and 6.) learning the multiplication tables from the two's thru the ten's. And such skills and knowledge are to be gained by students moving beads back and forth on the rope, to the “counting block”, or to the “non-counting block”. And this row of beads on a rope or cord or wire may be of different colors to help the student learn the various math processes listed above. And by being able to see the numbers assigned to each bead, above or below that bead, gives a type of visual feedback to the user. And by the process of moving one or more beads into the counter group, or away from the counter group, gives the student user a type of motor action which helps enhance memory for these choices and accompanying actions. It has been found that many young children seem to learn best and quickest when they have both sensory and motor activities involved in the areas to be learned.

4. Claim 4 is to have and use beads of up to ten colors in the mechanism described in claims: 1, 2, and 3, to help the user become aware of the various math processes; such as our numbering system having a base of ten; and of the multiplication tables having certain numbers appearing at set intervals. An example of this would be to have every third bead be of green color, and the other beads would be white.

5. Claim 5 is to have this apparatus constructed so that the beads with their various colors be easily and quickly removed from this rope or cord. And then the user, or mentor can rapidly place a different pattern of colored beads, to help with a new math skill or a new math process. An example of this would be to have only twenty beads on the rope, but the odd numbers would be white, and the even numbers would be red; and this could be used to help the student learn the 2's times tables. And these white and red beads could be rapidly removed, and quickly replaced by a color pattern of two white beads, followed by one green bead. And this could help the young learner master the 3's times tables.
